(19) United States
(12) Patent Application Publication
(10) Pub. No.: US 2013/0199047 A1
(43) Pub. Date: Aug. 8, 2013

(54) CUTTING TOOL

(71) Applicant: Martin Herlitz, Remscheid (DE)

(72) Inventor: Martin Herlitz, Remscheid (DE)

(21) Appl. No.: 13/816,554

(22) PCT Filed: May 27, 2011
(86) PCT No.: PCT/DE11/01195

§ 371 Date: Apr. 26, 2013

(30) Foreign Application Priority Data
Aug. 13, 2010 (DE) 10-2010-034-395.1

(51) Int. Cl. B26B 1/08; B26B 29/02

(52) U.S. Cl. CPC B26B 1/08; B26B 29/02
USPC 30/162; 30/151

(57) ABSTRACT

According to a first aspect, the invention relates to a cutting tool, in particular for severing planar materials, such as paper, cardboard, films, strips, and mats, as well as bands, ropes, and similar material, comprising a gripping area and a tool head (23), wherein a guide channel (24) is formed between guide surfaces (25a, 25b) of the tool head (23), wherein the material to be cut can be fed to the cutting edge (S) of a blade (15) only through the guide channel (24). The invention is characterized in that the blade (15) can be moved between a safety position, in which a cutting edge (S) of the blade (15) is protected by a cover so as to be inaccessible to a user, and a cutting position, in which the cutting edge (S) is accessible only through the guide channel (24).

The invention relates principally to a cutting tool as set forth in the preamble of claim 1.

A cutting tool of this type is disclosed in DE 69721973 [U.S. Pat. No. 5,737,842]. The cutting tool has a grip and a tool head. The tool head is provided with a guide notch through which the material to be cut can be guided to a cutting edge. The cutting edge is firmly clamped in the tool head. The tool head is hook-shaped and has a free end.

In addition, DE 7623799 [U.S. Pat. No. 4,134,206] discloses a cutter of this type. The cutter has a grip and a tool head with a guide notch. Material to be cut can be guided through the guide notch to a cutter blade fixed between a contact face of the tool head and a retaining plate that can be screwed onto the tool head. The guide notch is of small width, thereby allowing thin cutting material to be guided toward the blade while the user cannot injure him/herself on the blade. This is because the width of the guide notch does not allow, for example, the user's finger to be inserted.

The object of this invention is therefore to create a cutting tool with which even thick materials can be cut but which nevertheless provides a high level of safety so that the user cannot be injured by the tool.

The object is achieved in a first aspect of the invention by a cutting tool comprising the features of claim 1.

The principle of the invention consists in an approach whereby the blade is movably supported and can be moved between a cutting position and a safety position. The blade can be supported, for example such that it moves in a straight line and/or rotates, or carries a complex movement composed of straight-line motion and rotation.

In the cutting position, the cutting edge of the blade is accessible from the tool head through the guide notch. The material to be cut can be guided to the cutting edge. In the safety position, the blade can be moved to a position in which the cutting edge is covered. On movement between the cutting position and the safety position, the blade travels for example relative to the cover. The blade can for example be moved into a housing such that the cutting edge is covered by the housing walls so that it is no longer accessible to the user.

The guide notch can be made wide enough that thick material, for example of a thickness ranging up to 15 mm, can be guided to the blade when in the safety position.

It is possible to provide the cutting tool in such a form that the blade is in the guide notch only during the cutting action. The blade can be retracted automatically into the safety position as soon as the operating button is no longer actuated. Automatic retraction of the blade can be done by a biasing element.

In a first embodiment, the cutting tool can be provided for example in such a form that the blade is moved to the safety position whenever it leaves the cutting material even if the operating button is actuated.

The cutting tool according to the invention thus makes it possible to provide a wide guide notch in order to cut relatively thick materials while nevertheless having a high level of safety. This is because the risk of injury is low when the blade can move to a safety position despite the fact that the guide notch is of a width that allows the parts of the body of the user to fit in the guide notch.

The guide notch within the scope of the invention is an opening formed between faces of a guide for conducting the material to be cut to the cutting edge of the blade and for moving away the cut material. The guide gate has outfeed flanks or faces. They are directed oppositely away from each other at the notch. At least two guide grooves can be formed, for example for carrying away the severed material. Due to its dimensions, the guide notch furthermore prevents material from being fed in that exceeds a specified size. Parts of the body that exceed the dimensions of the guide notch can also not reach the blade.

The blade is retained, for example on a blade support slide that can be moved between a front position and a rear position. In the front position, the blade is in the cutting position. In the rear position, the blade is in the safety position and the cutting edge is covered, thereby preventing the user from contacting the cutting edge.

One embodiment of the invention is characterized in that the blade support forms an subassembly together with an insert that can be releasably fitted in the casing. The blade support can, for example be slidable in a guide of the insert. The blade support is guided on the insert, for example, so as to enable movement of the blade support relative to the insert between the safety position and the cutting position.

The object is achieved in a second aspect of the invention comprising the features of claim 4.

A blade protector is movably supported on the casing. The blade protector can be moved by at least one operating button between a safety position and a cutting position.

When in the safety position, the blade protector is moved over a cutting edge of the blade that is at least partially in the guide notch such that the cutting edge is inaccessible to a user.

The blade protector covers the cutting edge. In the cutting position, the blade protector is separated from the cutting edge, thereby allowing material to be guided to the cutting edge for cutting. The blade can then, for example, be fixed on the housing of the cutting tool so that the cutting edge always projects at least partially into the guide notch.

Actuating an operating button, for example enables the blade protector to be moved to the cutting position in which the protector is removed from the cutting edge. Following the cutting action, the blade protector, for example can be moved to the safety position. The movement to the safety position can be automatic once the operating button is no longer actuated. A spring, for example, can bias the blade protector into the safety position.

The lade protector within the scope of the invention can be any cover preventing contact with the cutting edge. The cover can be, for example of plastic or metal.

The following embodiments relate both to the first aspect and also the second aspect of the invention.

One embodiment is characterized in that the blade support or the blade protector is biased into the safety position by a biasing element. The biasing element can be, for example, an elastically deformable element, such as for example a spring. The biasing element can be tensioned, for example by movement from the safety position to the cutting position. The spring is attached for example to the blade support or the blade protector, and to the casing of the cutting tool. The biasing element can, for example move the blade or the blade protector from the cutting position to the safety position once the operating button is no longer actuated. In an alternative embodiment, the biasing element can, for example move the blade or the blade protector from the cutting position to the safety position, despite the fact that the operating button has been actuated, after a cutting action has been effected.

In one embodiment, the grip and/or the tool head are at least partially associated with the casing that has a seat. The seat makes it possible to remove the blade from the guide notch after the cutting action and to locate it in the seat where it is inaccessible to the user. The housing walls can for example create the cover for the cutting edge of the blade. No injury to the user is possible when the blade is in the seat. It is furthermore possible to locate the blade protector at least partially within the seat. The blade protector can be located for example at least partially in the seat when in the cutting position. In the safety position, one section of the blade protector can be in the seat. It is furthermore possible to accommodate the mechanism for moving the blade or the blade protector in the seat.

Another embodiment of the invention is characterized in that the casing has an opening through which the blade or the blade protector can pass when moving between the safety position and the cutting position, where the opening is immediately adjacent to the guide notch. A front side of a grip provided as housing can for example delimit the guide notch. If the opening is provided on the front side of the casing, the blade is moved into the guide notch as soon as it emerges from the opening of the casing.

In another embodiment, the tool head forms a free end region. The free end region for example delimits the guide notch. The free end region can be for example tapered to a point. This then enables the material to be cut to be engaged from behind by the end region. It is possible for example to provide opposing grooves on the free end region, the grooves at least partially creating the guide notch.

Further advantages of the invention are revealed based on an illustrated embodiment shown in the figures. Therein:

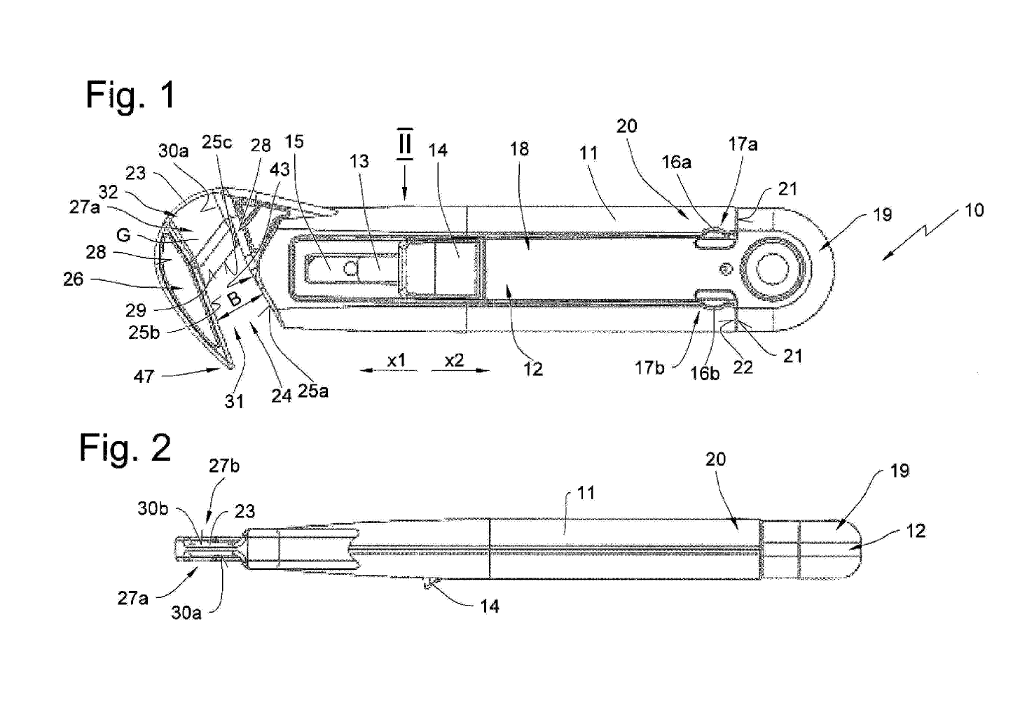

FIG. 1 is a schematic side view of the cutting tool with its blade in a safety position;

FIG. 2 is a schematic view in the direction of arrow II in FIG. 1;

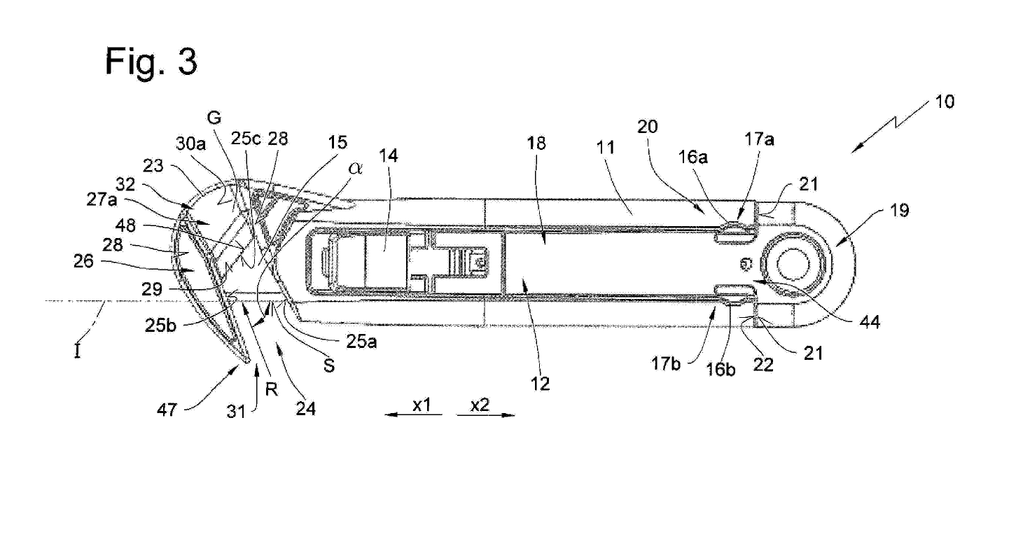

FIG. 3 is like FIG. 1 and is a side view of the cutting tool with the blade in a cutting position;

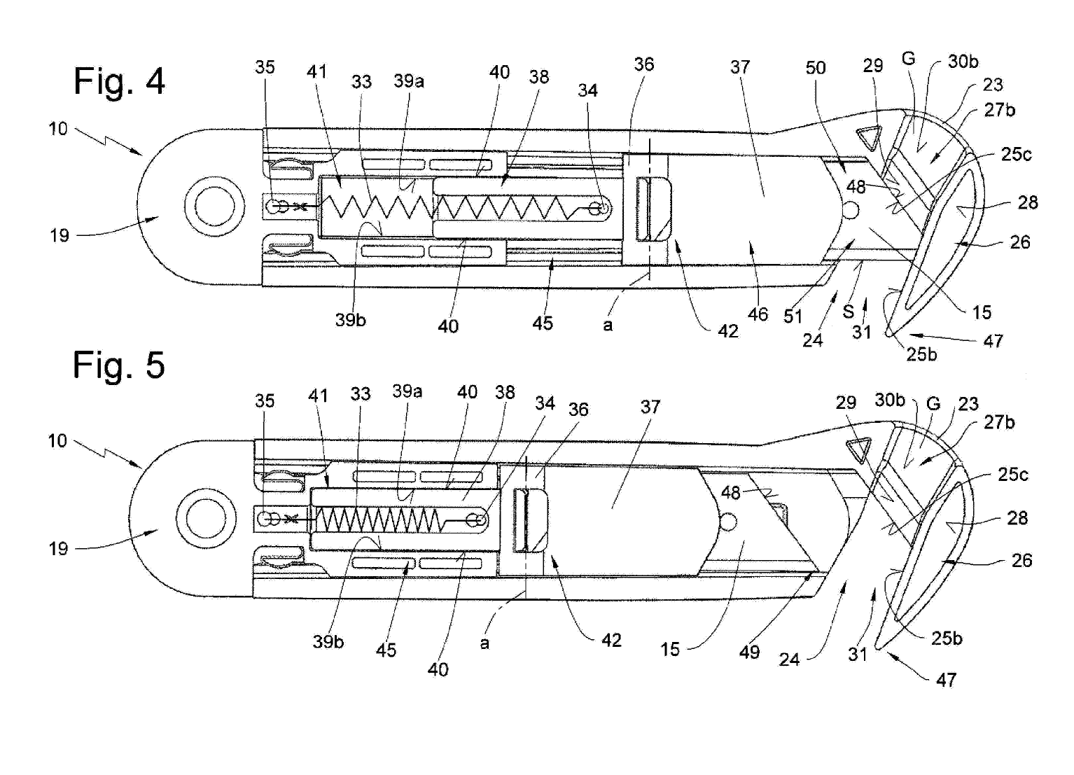

FIG. 4 is a schematic partly sectional view of the cutting tool in the cutting position;

FIG. 5 is like FIG. 4 and shows the cutting tool in the safety position.

The complete cutting tool is identified in the figures at reference 10. Identical reference characters in the various figures denote the same parts including wherever small-type characters are added or omitted.

The cutting tool 10 is designed, in particular, for cutting paper, cardboard, foil and films, strips, mats, ribbons, ropes, and similar material. As seen in FIG. 1, the tool 10 has a casing 11 comprising a grip 12 and a tool head 23. A guide notch 24 is formed on the tool head 23 so that the material to be cut can be guided to a cutting edge S of a blade 15 not shown in FIG. 1, and the cut material can be carried away after being cut.

The guide notch 24 has a region 31 formed as an opening. The opening is delimited by inner faces 25a, 25b, and 25c. The faces 25a and 25b are guides.

The guide notch 24 is of a width B that enables even relatively thick materials to be guided to the blade 15. The width B measures, for example 15 mm. A portion 32 of the guide notch 24 has a bight G forming oppositely opening grooves 27a and 27b. The guide notch 24 is thus formed in the region 31 as a slot, and is divided in the region 32 into the oppositely open grooves 27a and 27b that are separated by the bight G. Flat flanks 30a and 30b of the grooves 27a and 27b are recessed relative to an outer surface 28.

The severed material is conducted away from the blade 15 (not shown in FIG. 1) by the grooves 27a and 27b. The bight G has angled faces 29 on both sides of the cutting head 23. The cut material is guided by the angled faces 29 to respective flanks 30a and 30b where the bight G is of greater width than the blade 15.

The tool head 23 has a free end part 26 that forms the inner face 25b. This free end part 26 tapers to a point 47. This enables the material being cut to be engaged from behind by the end part 26 and pulled into the guide notch 24. Here the faces 25a and 25b function as guides for the material.

The blade 15 is movably supported in the casing 11. In this embodiment, the blade 15 is supported for straight-line movement. In an alternative embodiment, the blade 15 can, however, also be pivotable, or carry out a straight-line and rotational movement, or a complex motion composed of rotation and straight-line motion.

In the safety position shown in FIGS. 1, 2, and 5, the blade 15 has been retracted out of the guide notch 24. In the safety position, the blade 15 is completely recessed in a seat 45 of the grip 12 forming part of the casing and is thus inaccessible to the user. It is thus impossible for any injury to occur to the user in the safety position.

In the cutting position, a blade point 49 slides into an opening of the free end part 26 and is thus inaccessible. A support region 50 of the blade 15 is still in the seat 45. A center region 51 of the blade 15 extends across the guide notch 24 such that a cutting edge S of the center region is accessible, thereby enabling cutting to be effected.

A longitudinal axis I of the cutting edge S can be oriented in the cutting position, for example such that it is perpendicular to or at an acute angle a to a feed region R in which the material is moved into the guide notch 24. A back edge 48 of the blade 15 contacts the inner face 25c of the bight G.

The blade 15 can be moved by the operating button 14 between the safety position and the cutting position (see, for example FIG. 3) in which the blade 15 moves partially out of the seat 45 through a front housing opening 43. The operating button 43 is coupled for joint movement to the blade support 13. Moving the operating button 14 from the safety position in a forward direction x1 enables the blade support 13 to be moved forward to the cutting position shown in FIG. 3.

FIG. 4 is a schematic sectional view of the tool 10. As seen in FIG. 4, the blade 15 is retained in the blade support 13 that can be moved between a rear position (see, for example FIG. 5) and a front position (see, for example FIG. 4). When the blade support 13 is in the rear position, the blade 15 is in the safety position; when blade support 13 is moved to the front position, the blade 15 is in the cutting position.

A tension spring 33 is hooked on an attachment element 34 of blade support 13 and an attachment element 35 of an insert 19 fitted to the rear end of the casing 11. Whenever the blade support 13 is moved relative to the insert 19 from the safety position to the cutting position, the insert tensions the spring 33 elastically. The blade support 13 is thus biased rearward in a direction x2 from the cutting position to the safety position as soon as the operating button 14 is no longer being actuated.

The blade support 13 has an extension 38 with an outer surface 40 that is guided along confronting guide faces 39a and 39b of a guide groove 41 formed on the insert 19. This enables the blade support 13 and the insert 19, as well as the spring 33, to be manipulated as a subassembly.

In order to attach the insert 19 to the casing 11, it has latch elements 16a and 16b that attach the insert 19 to the casing 11 by engaging in respective detent recesses 17a and 17b of the casing 11. In order to ensure that the parts of the subassembly of the blade support 13 and the insert 19 can be assembled together, a slot 18 is formed in the casing 11 along which the operating button 14 can be moved to the position shown in FIG. 1, the button protruding laterally beyond the casing. The insert 19 can be inserted into the casing 11 through an opening 44 in a rear end 20 of the casing 11 up until a stop face 22 of the insert 19 strikes an end face 21 of the casing 11.

Replacing the blade 15 is possible by removing the insert 19 from the casing 11. In order to separate from the casing 11, the insert 19 is moved in the forward direction x2 relative to the casing 11. For this to occur, the elastic retaining force of the latch elements 16a and 16b must be overcome. Once the subassembly consisting of the blade support 13 and the insert 19 has been completely extracted from the seat 45 of the casing 11, the blade 15 can be removed in the normal manner from a blade seat 46 by swiveling a latch means 37 about an axis a of a swivel joint 42 relative to a housing 36 of the blade support 13.

Assembly is performed in the reverse order whereby the subassembly consisting of the blade support 13 and the insert 19 is reinserted into the opening 44 until the latch elements 16a and 16b snap into the recesses 17a and 17b. Once these engage, the cutting tool is again ready for use.

1. A cutting tool for severing flat materials, the cutting tool comprising a grip and a tool head, a guide notch being formed between guide faces of the tool head such that the material to be cut can be guided to a cutting edge of the blade only through the guide notch, wherein the blade can be moved between a safety position in which a cutting edge of the blade is inaccessibly protected for a user by a cover, and a cutting position in which the cutting edge is exposed in a guide notch.

2. The cutting tool according to claim 1, wherein the blade is supported on a blade support.

3. The cutting tool according to claim 1, wherein the blade support together with an insert creates an subassembly.

4. A cutting tool for severing flat materials, the cutting tool comprising a grip and a tool head, a guide notch being formed between guide faces of the tool head such that the material to be cut can be guided to a cutting edge of the blade only through the guide notch, wherein a blade protector can be switched between a safety position in which the blade protector is moved over a cutting edge of the blade, the cutting edge being at least partially in the guide notch, such that cutting edge is inaccessibly unengageable with a user, and a cutting position in which the blade protector is removed from the cutting edge such that cutting can be effected.

5. The cutting tool according to claim 1, wherein the blade protector or the blade are biased by a biasing element into the safety position.

6. The cutting tool according to claim 1, wherein the grip or the tool head are formed at least partially by a housing with a seat.

7. The cutting tool according to claim 6, wherein the blade can be moved between a first position that is at least partially inside the seat and a second position that is at least partially in the guide notch.

8. The cutting tool according to claim 6, wherein a housing opening is adjacent the guide notch.

9. The cutting tool according to claim 1, wherein the tool head has a free end region that at least partially delimits the guide notch.

10. The cutting tool according to claim 1, wherein the blade can be moved to the cutting position by actuating an operating button, and that the blade can be moved automatically to the safety position after cutting.

11. A cutting tool comprising:
a casing extending along an axis and having a head formed with a laterally open notch;
a support axially shiftable in the casing relative to the notch; and
a blade having a cutting edge, fitted to the support, and shiftable with the support between a forward cutting position with the cutting edge extending across the notch, and a rearward safety position with the cutting edge retracted into the casing and not exposed in the notch.

12. The cutting tool defined in claim 11, further comprising:
a spring engaged between the support and the casing and biasing the casing and the blade rearward into the safety position.

13. The cutting tool defined in claim 11, wherein the support is slidable in the casing.

14. The cutting tool defined in claim 11, wherein the head is formed as a laterally open fork having front and back longitudinally spaced parts with confronting faces defining the notch.

15. The cutting tool defined in claim 14, wherein the front part is formed with a rearwardly open cavity in which a point of the blade fits in the cutting position.
